(19) United States
(12) Patent Application Publication
(10) Pub. No.: US 2016/0240944 A1
(43) Pub. Date: Aug. 18, 2016

(54) Connector Assembly and Connector

(71) Applicant: Tyco Electronics Japan G.K., Kanagawa (JP)

(72) Inventor: Yoshihiko Kodaira, Kanagawa (JP)

(73) Assignee: Tyco Electronics Japan G.K., Kanagawa (JP)

(21) Appl. No.: 15/044,738

(22) Filed: Feb. 16, 2016

(30) Foreign Application Priority Data
Feb. 16, 2015 (JP) 2015-027764

(51) Int. Cl. H01R 12/71; H01R 13/73; H01R 24/60

(52) U.S. Cl. CPC H01R 12/716; H01R 24/60; H01R 13/73

(57) ABSTRACT

A connector assembly is provided and includes a first connector and a second connector. The first connector includes a first housing and a pair of first support metal fittings provided at both end portions of the first housing. Each of the pair of first support metal fittings include a pair of first bent portions positioned along sides of the first housing, a second bent portion positioned between the pair of first bent portions, and a pair of third bent portions extending between the pair of first bent portions and the second bent portion. The second connector includes a second housing with first support metal fittings receiving portions and a pair of second support metal fittings. The pair of second support metal fittings are disposed at both end portions of the second housing. Each of the pair of second support metal fitting includes a pair of first reinforcement portions.

### CROSS-REFERENCE TO RELATED APPLICATIONS

This application claims the benefit of the filing date under 35 U.S.C. §119 (a)-(d) of Japanese Patent Application No. 2015-027764, dated Feb. 16, 2015.

### FIELD OF THE INVENTION

The present invention relates to a connector assembly and, more particularly, to a connector assembly having a pair of connectors mated with each other.

### BACKGROUND

Connector assemblies having a pair of connectors that are mounted on substrates (including flexible printed circuits), respectively, and mated with each other are commonly used. However, such connector assemblies are frequently required to be reduced in size and reduced in height. Further, in recent years, many connector assemblies require multi-polarization. As a result, when a pair of connectors is mated with each other, a predetermined tolerance is required regarding a misalignment to each other. That is, such a structure is required that, even when mating has been performed in a state where misalignment to each other has occurred, the connectors are induced to a right mating position to be mated with each other correctly.

In Japanese Patent Application JP 2014-199799 A, a connector having support metal fittings with a guide portion inclined inward to induce a mating connector to a right mating position at both end portions of a housing in a longitudinal direction of the housing is disclosed.

However, the support metal fitting provided in the disclosed connector is formed by bending. Therefore, sheared faces are exposed at corners of an upper face of the support metal fitting. When a mating connector mated with this connector is mated with the connector during misalignment to each other, a resin-made housing comes in contact with the support metal fitting. Therefore, there is a possibility that the housing is shaved or deformed by the sheared face of the support metal fitting.

As a result, it is considered that the mating connector mated with the connector provided with the support metal fittings is also provided with support metal fittings at portions coming in contact with the support metal fittings of the connector. However, even in this case, when the support metal fitting of the mating connector is also formed by a bending, there is a possibility that the sheared faces of the support metal fittings of both the connectors come in contact with each other. In this case, such an event may occur that guiding function (inducing function) to a right position when a misalignment has occurred is poor.

### SUMMARY

The invention has been made in view of the above circumstances and an object thereof is to provide a connector assembly and a connector excellent in guiding function to perform guidance to a right mating position.

Accordingly, a connector assembly is provided and includes a first connector and a second connector. The first connector includes a first housing and a pair of first support metal fittings provided at both end portions of the first housing. Each of the pair of first support metal fittings include a pair of first bent portions positioned along sides of the first housing, a second bent portion positioned between the pair of first bent portions, and a pair of third bent portions extending between the pair of first bent portions and the second bent portion. The second connector includes a second housing with first support metal fittings receiving portions and a pair of second support metal fittings. The pair of second support metal fittings are disposed at both end portions of the second housing. Each of the pair of second support metal fitting includes a pair of first reinforcement portions.

### BRIEF DESCRIPTION OF THE DRAWINGS

The invention is explained in greater detail below with reference to embodiments and the appended drawings of which:

FIG. 1A is a perspective view of a first connector of a connector assembly according to the invention;

FIG. 1B is a perspective view of first support metal fittings of the first connector of FIG. 1A;

FIG. 2A is a perspective view of a second connector of the connector assembly according to the invention, which is to be mated with the first connector of FIG. 1;

FIG. 2B is a perspective view of second support metal fittings of the second connector of FIG. 2A;

FIG. 3 is a perspective view the connector assembly according to the invention;

FIG. 4(A-1) is a front perspective view of the first support metal fitting and the second support metal fitting before mating;

FIG. 4(A-2) is a rear perspective view of the first support metal fitting and the second support metal fitting before mating;

FIG. 4(B-1) is a front perspective view of the first support metal fitting and the second support metal fitting after mating;

FIG. 4(B-2) is a rear perspective view of the first support metal fitting and the second support metal fitting after mating;

FIG. 5 is another perspective view of the connector assembly according to the invention before the first connector and the second connector are connected to each other;

FIG. 6 is a plan view of the connector assembly of FIG. 5;

FIG. 7 is a cross-sectional view taken along line A-A shown in FIG. 6;

FIG. 8A is a cross-sectional view taken along line B-B shown in FIG. 6;

FIG. 8B is an enlarged view showing the detail of section R shown in FIG. 8A;

FIG. 9A is a perspective view of another second connector; and

FIG. 9B is a perspective view of the second support metal fittings according to the invention.

### DETAILED DESCRIPTION OF THE EMBODIMENT(S)

Embodiments of the invention will be explained below with reference to the Figures.

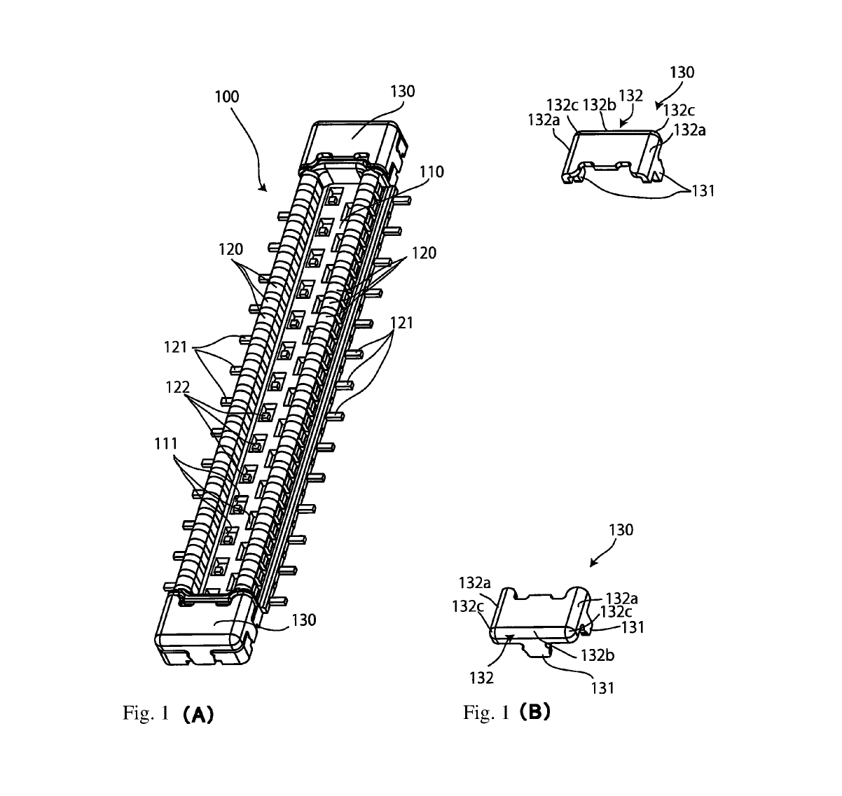

As shown in FIGS. 1A and 1B, the first connector 100 is surface-mount type connect to be mounted on a board (not shown; for example, a flexible printed circuit). The first connector 100 generally includes a first housing 110, a plurality of contacts 120, and a pair of support metal fittings 130.

In the shown embodiment, the first housing 110 is approximately rectangular shaped.

The plurality of contacts 120 are arranged in two rows along two longitudinal sides of the first housing 110, respectively. The plurality of contacts 120 include first soldering connecting portions 121 projecting from the longitudinal side to outside of the housing 110 are present in these contacts 120. Further, the plurality of contacts 120 include second soldering connecting portions 122, which are provided inside the first housing 110, are also provided. The first soldering connecting portions 121 and the second soldering connecting portions 122 are arranged alternately in each row in which the plurality of contacts 120 are arranged. Further, openings 111 are provided and corresponding to the respective second soldering connecting portions 122 individually. The openings 111 allow visual inspection of soldered states of the second soldering connecting portions 122 that are formed along the first housing 110. All of the first soldering connecting portions 121 and the second soldering connecting portions 122 are configured to be soldered to the board.

In addition, the first support metal fittings 130 are structural members that reinforce the mounting strength of the first housing 110 to the board. The first support metal fittings 130 provided at both end portions of the first housing 110, along a length thereof. Each first support metal fitting 130 includes board connecting portions 131 provided along three sides thereof that correspond to an end face of the housing 110. The board connecting portions 131 are configured to be soldered and secured to the board. That is, the first support metal fitting 130 holds the end portion of the housing 110 along a length thereof and it is soldered and secured to the board. Thereby, the first housing 110 is firmly secured to the board using the first support metal fittings 130.

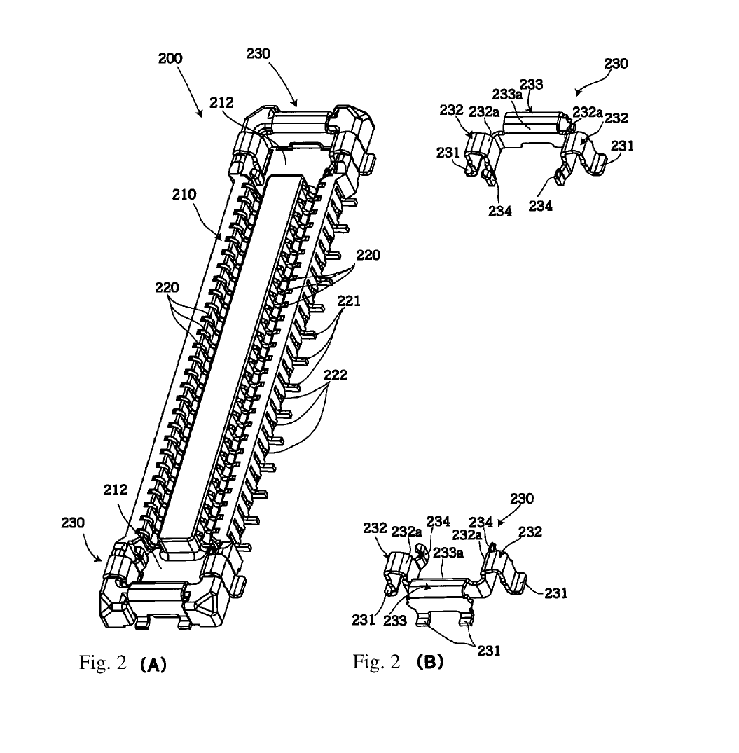

Here, the first support metal fittings 130 include a pair of first bent portions 132a bent toward the soldering connecting portion 131 along both sides of the first housing 110 with respect to a width thereof. The soldering connecting portion 131 is bent away from a second connector 200 (see FIG. 2) described later in a direction of mating to the second connector 200.

Further, the first support metal fitting 130 includes a second bent portion 132b bent toward the soldering connecting portion 131 at the end portion of the housing 110 along a length thereof.

Furthermore, the first support metal fitting 130 includes third bent portions 132c bend toward the soldering connecting portion 131 and formed at two portions in an oblique direction intersecting both of the above-described longitudinal direction and widthwise direction. This third bent portion 132c is a portion composed of bending continued to both of the first bent portion 132a which is bending in the widthwise direction and the second bent portion 132b which is bending along a length thereof. That is, a bent portion 132 composed of the first to third bent portions 132a to 132c continued is formed in the first support metal fitting 130. That is, the bent portion 132 is continued from one of the first bent portions 132a formed in a first direction of the widthwise direction to the second bent portion 132b using one of the third bent portions 132c. In addition, the bent portion 132 is further continued from the second bent portion 132b to the other of the first bent portion 132a formed in a second direction of the widthwise direction via the other of the third bent portion 132c. In the shown embodiment, the continued bent portion 132 is drawn.

If misalignment is present when the first connector 100 is attempted to be mated with the second connector 200 (see FIG. 2), any portion of the continuing bent portion 132 comes in contact with the second connector 200. This will be described in detail later.

With reference to FIGS. 2A and 2B, the second connector 200 is shown and a surface-mount type connector for mounting to a board (for example, a ridge board; not shown). The second connector 200 is to be mounted to a board different from the board on which the first connector 100 is mounted. The second connector 200 generally includes a second housing 210, a plurality of contacts 220, and a pair of second support metal fittings 230.

In the shown embodiment, the second housing 210 is approximately rectangular shaped. The second housing 210 has receiving portions 212 disposed at both end portions of the second housing 210 along a length thereof. The pair of first support metal fittings 130 provided on the first connector 100 (see FIG. 1) correspond to receive the recessed portions 212, respectively.

The plurality of contacts 220 are contacts which are configured to be connected to the plurality of contacts 120 of the first connector 100, respectively. The plurality of contacts 220 are arranged in two rows along a length thereof and in the same manner as the plurality of contacts 120 of the first connector 100.

Each contact 220 includes a first soldering connecting portion 221 projecting largely from the housing 210 along a width thereof. Further, each contact includes a second soldering connecting portion 222 which does not protrude largely from the housing 210. The plurality of contacts 220 are arranged along two rows in the embodiment shown. The plurality of contacts 220 are also arranged alternately. The first soldering connecting portions 221 and second soldering connecting portions 222 are configured to be soldered and connected on the board.

Further, the second support metal fittings 230 are provided at both end portions of the second housing 210 along a length thereof and they are members for reinforcing mounting strength of the second housing 210 to the board. The second support metal fitting 230 is provided with two board connecting portions 231 extending in a direction of projecting from an end face of the second housing 230 along a length thereof. Further, the second support metal fitting 230 is also provided with board connecting portions 231 extending in directions of projecting from both side faces of the second housing 210, respectively. The second support metal fitting 230 holds the end portion of the second housing 210 along a length thereof and a total of four board connecting portions 231 are configured to be soldered and secured to the board regarding one of the second support metal fittings 230. The second housing 210 is firmly secured to the board via the second support metal fittings 230.

As shown, the second support metal fitting 230 includes a pair of first reinforcement portions 232 and a second reinforcement portion 233. The pair of first reinforcement portions 232 reinforces both side portions defining the receiving portion 212 of the second housing 210. Further, the second reinforcement portion 233 reinforces an end portion positioned further beyond the receiving portion 212. The pair of first reinforcement portions 232 and the second reinforcement portion 233 have first support metal fittings receiving portions angled sections 232a and 233a constituting a downward slope toward the receiving portion 212. In the shown embodiment, these angled sections 232a and 233a are downward slopes inducing the first support metal fitting 130 (see FIG. 1) of the first connector 100 to be mated into the receiving portion 212.

Here, the first reinforcement portions 232 connect to lower ends of the board connecting portions 231 and rise alongside walls of the second housing 210 to form the above-described angled sections 232a. These first reinforcement portions 232 further extend from the angled sections 232a along inner walls forming the receiving portion 212 of the second housing 210. That is, the first reinforcement portion 232 has such a shape as to straddle a side face of the second housing 210 and the inner wall forming the receiving portion 212. The first reinforcement portion 232 continues to the second reinforcement portion 233 in the inner wall side.

Further, the second reinforcement portion 233 is configured such that a lower end thereof connects to the board connecting portions 231 on the side of the end face along a length thereof and rises along the side wall of the second housing 210 to form the above-described angled section 233a. The second reinforcement portion 233 further extends from the angled section 233a along the inner wall forming the receiving portion 212 of the second housing 210. That is, the second reinforcement portion 233 has a shape straddling the end face of the housing 210 and the inner wall forming the receiving portion 212 and similar to that of the first reinforcement portion 232. The second reinforcement portion 233 continues to each of the pair of first reinforcement portions 232 along both sides of the inner wall side of the second reinforcement portion 233 to form the receiving portion 212 along a width thereof.

As shown, the second reinforcement portion 230 further includes a pair of contacts 234 electrically connected to (transmitting power to) the first reinforcement metal 130 (see FIG. 1). Each of these contacts 234 has such a shape as to extend the inner wall side of each first reinforcement portion 232 inward along a length thereof of the second housing 210. A distal end portion extending inward along a length thereof is configured to electrically connect to the first support metal fitting 130.

When the contacts 234 are electrically connected to (transmit power to) the first support metal fitting 130, the contacts 234 must come in contact with the first support metal fitting 130 through a predetermined pressure of contact. Here, in the second support metal fitting 230, the first reinforcement portion 232 doubles as a spring applying contact pressure on the contact 234. Thereby, the predetermined contact pressure is realized by utilizing a small space.

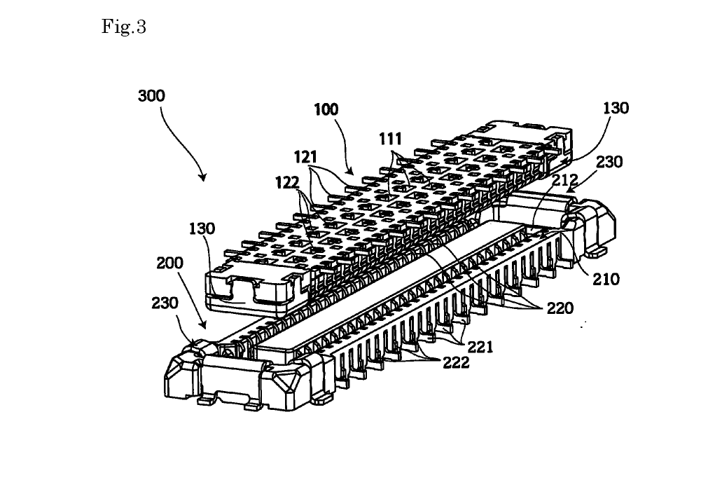

Now with reference to FIG. 3, a connector assembly 300 according to the invention is shown and includes the first connector 100 shown in FIG. 1 and the second connector 200 shown in FIG. 2.

As shown, the first connector 100 put in such an attitude that the upper face shown in FIG. 1 faces downward (toward the second connector 200) is shown. The first connector 100 is mated with the second connector 200 with this attitude at a mating time.

Incidentally, though a board is also not shown here, mounting is carried out such that the lower face of the first connector 100 shown so as to face upward comes in contact with the board. Further, the second connector 200 is mounted to another board different from the board of the first connector 100, such that a lower face thereof comes in contact with the other board.

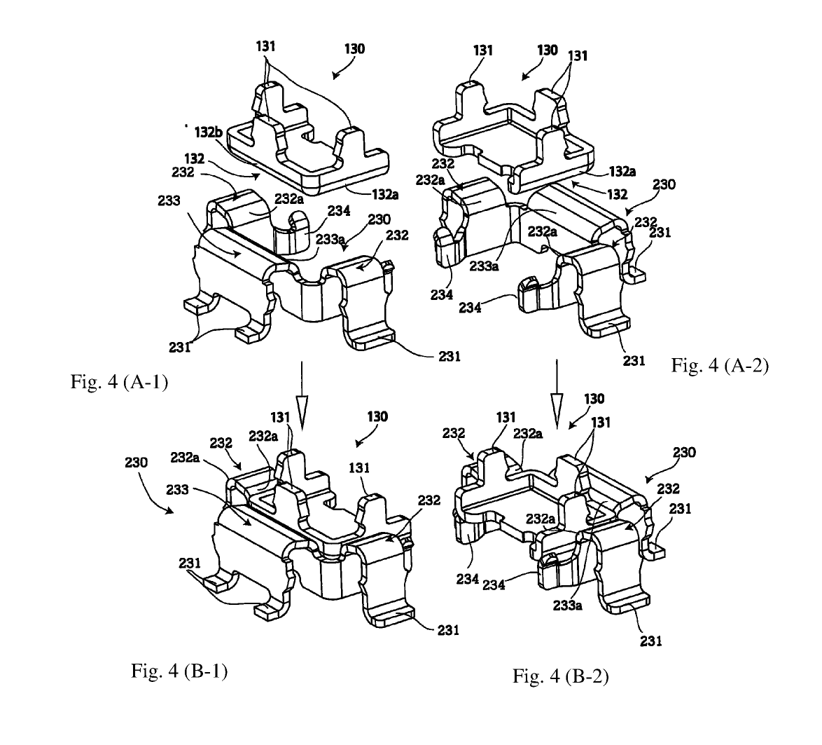

Now with reference to FIGS. 4(A-1) and 4(B-2), mating between the first support metal fitting 130 and the second support metal fitting 230 will be described. The first support metal fitting 130 is fitted in a space surrounded by the pair of first reinforcement portions 232 and the second reinforcement portion 233 of the second support metal fitting 230. In the second housing 210, the reception space 212 (see FIG. 2) receiving the first support metal fitting 230 therein is formed at a portion corresponding to the surrounded space.

Further, the contacts 234 provided on the second support metal fitting 230 come in contact with distal ends of the first bent portions 132a of the first support metal fitting 130, so that the first support metal fitting 130 and the second support metal fitting 230 are electrically connected to each other. In the first support metal fitting 130, the board connecting portions 131 are soldered and secured to pads on the board (not shown) on which the first connector 100 is mounted. Further, in the second support metal fitting 230, the board connecting portions 231 are soldered and secured to the pads on the board (not shown) on which the second connector 200 is mounted. Therefore, when the first connector 100 and the second connector 200 are mated with each other, the unillustrated pads on both of the first connector 100 and the second connector 200 are connected to be put in the same potential via the first support metal fittings 130 and the second support metal fitting 230.

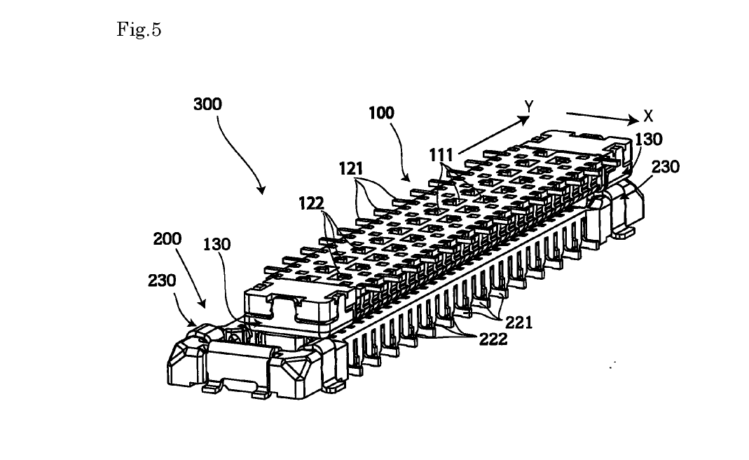

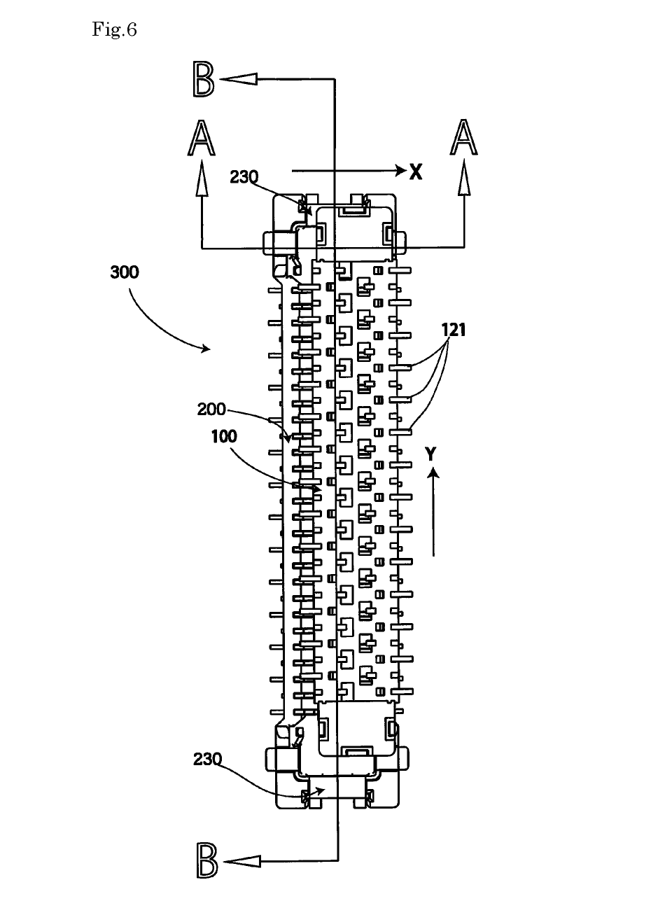

Now with reference to FIGS. 5 and 6, the connector assembly is shown and includes the first connector 100 and the second connector 200. The first connector 100 and the second connector 200 are positioned relative to each other. On the other hand, the first connector 100 shown in FIG. 5 and FIG. 6 is put in a position misaligned to the second connector 200 regarding an orientation in a widthwise direction X, and it is also put in a position misaligned regarding an orientation in a longitudinal direction Y. In this embodiment, even when a misalignment in a range from +0.3 mm to −0.3 mm is present in each of the widthwise direction and the longitudinal direction, guiding to a right mating position is performed at a mating time.

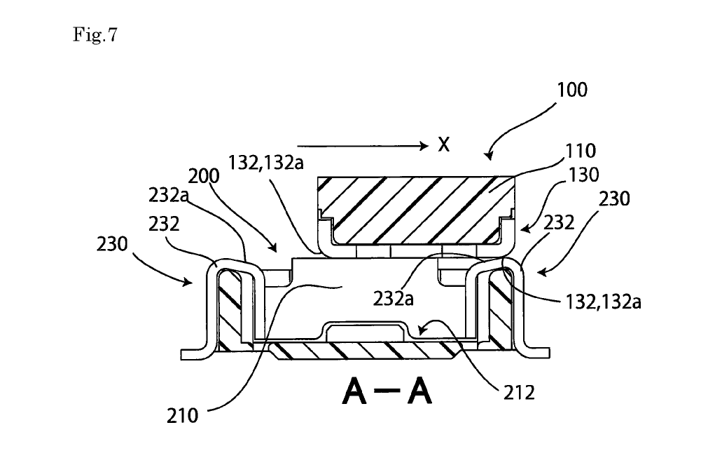

As shown in FIG. 7, the first connector 100 may come near the second connector 200 when it has been misaligned to the second connector 200 in an orientation of arrow X. At this time, as shown in this FIG. 7, one of the first bent portions 132a forming the bent portion 132 of the first support metal fitting 130 comes in contact with the angled section 232a of one of the second reinforcement portions 232 of the second support metal fitting 230. The angled section 232a forms a downward slope toward the receiving portion 212 of the second housing 210.

Further, the third bent portion 132c (see FIG. 1) continues to the first bent portion 132a of the first support metal fitting 130, where a sheared face is not present. Therefore, the first support metal fittings 130 are guided smoothly into the receiving portions 212 by the second support metal fittings 230 so that the first connector 100 is securely mated with the second connector 200.

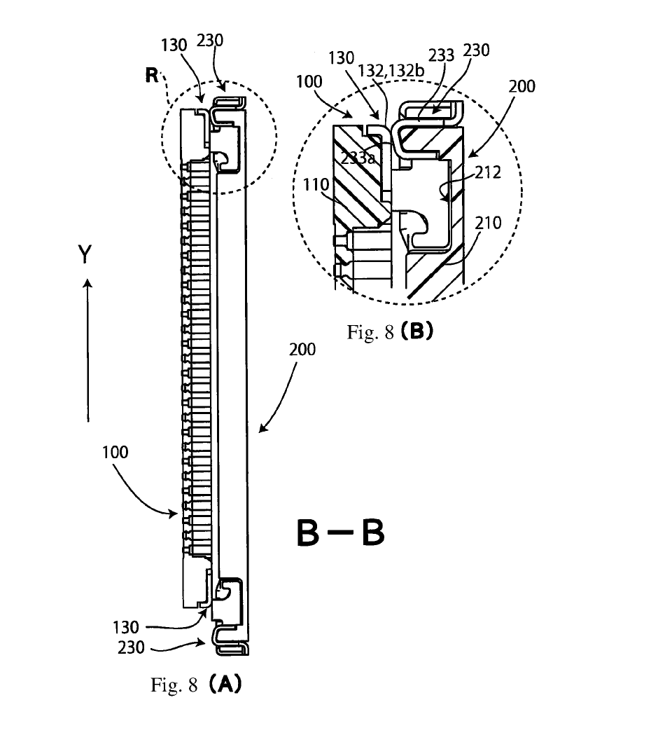

As shown in FIG. 8, the first connector 100 comes near the second connector 200 when it has been misaligned to the second connector 200 in an orientation of arrow Y along a length thereof. At this time, the second bent portion 132b of the first support metal fitting 130 comes in contact with the angled section 233a of the second reinforcement portion 233 of the second support metal fitting 230. The angled section 233a is also a downward slope toward the receiving portion 212. The third bent portions 132c (see FIG. 1) continues to both sides of the second bent portion 132b of the first support metal fitting 130 along a width thereof, where a sheared face is not present. Therefore, the first support metal fitting 130 is smoothly guided toward the receiving portion 212 by the second support metal fitting 230, so that the first connector 100 is securely mated with the second connector 200.

Here, even if a misalignment is present, contact occurs between the first support metal fitting 130 and the second support metal fitting 230. On the other hand, if a metal and a resin come in contact with each other, the resin tends to be shaved or crushed, which may result in occurrence of mating failure. In the case of the invention, a structure where metals come in contact with each other is adopted, so that occurrence of mating failure is avoided.

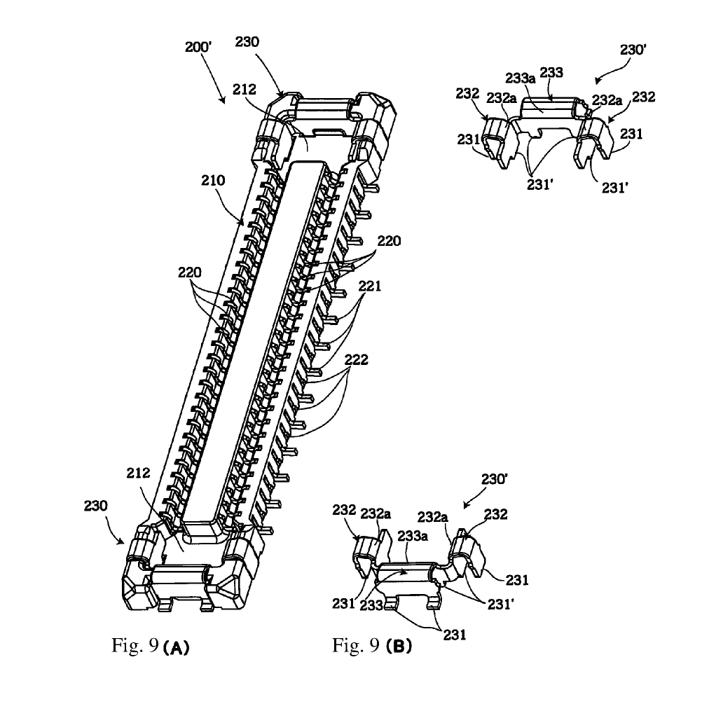

With reference to FIG. 9, another second connector 200′ is shown and is also a connector configured to be mated with the first connector 100 shown in FIG. 1.

A difference between the second connector 200′ shown in FIG. 9 and the second connector shown in FIG. 2 lies in a shape of a second support metal fitting 230′. As shown, the second support metal fitting 230′ does not include contacts 234 provided on the second support metal fitting 230 shown in FIG. 2. That is, the second connector 200′ is a connector that does not support electrical connection.

In the second support metal fitting 230′, board connecting portions 231′ are also provided on inner wall sides of each of a pair of first reinforcement portions 232 and a second reinforcement portion 233 facing the receiving portion 212. Thereby, the second connector 200′ is further secured to a board by the board connecting portions 231′ together with the board connecting portions 231 of the side face sides and the end face side. In the case of the second support metal fitting 230′ shown in this FIG. 9, however, a shape of the board connecting portion 231 of the first reinforcement portion 232 on a side of an outer face of the second housing 210′ is different from that shown in FIG. 2. In the case of the second support metal fitting 230′ shown in FIG. 9, since the board connecting portions 231′ are provided on the side of the receiving portion 212, the board connecting portion 231 on the side of the outer wall face suffices for a shape shown in this FIG. 9. Further, a widthwise size of the second connector 200′ is narrowed by the shape shown in FIG. 9.

According to the embodiment and the modified embodiment described above, even if a misalignment is present at a mating time, metal members come in contact with each other. Thereby, contact with resin is avoided, so that shaving or deformation of the resin is prevented and occurrence of mating failure is prevented. Further, the bent portion 132 continued from an end face side of the first connector 100 to both side face sides thereof is formed in the first support metal fitting 130 by drawing. Therefore, a sheared face of metal is not brought in contact with the support metal fitting 230, 230′, so that even if a misalignment is present, smooth inducement is performed.

Incidentally, the first support metal fitting may be formed by metal forming or cutting instead of the drawing work.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector assembly comprising:
a first connector having a first housing and a pair of first support metal fittings provided at both end portions of the first housing, each of the pair of first support metal fittings having a pair of first bent portions positioned along sides of the first housing, a second bent portion positioned between the pair of first bent portions and about one of both ends of the first housing, and a pair of third bent portions extending between the pair of first bent portions and the second bent portion; and
a second connector corresponding with the first connector and having a second housing with first support metal fittings receiving portions and a pair of second support metal fittings disposed at both end portions of the second housing, each of the pair of second support metal fitting having pair of first reinforcement portions positioned about side portions of the second housing and a second reinforcement portion positioned between the pair of first reinforcement portions and about one of both end portions of the second housing.

2. The connector assembly according to claim 1, wherein the pair of first reinforcement portions includes angled sections having downward slopes extending toward a receiving portion positioned between the pair of first reinforcement portions.

3. The connector assembly according to claim 2, wherein the second reinforcement portion includes an end angled section having a downward slope extending toward the receiving portion.

4. The connector assembly according to claim 1, wherein each of the pair of first reinforcement portions extends about an outer and inner wall of the second housing.

5. The connector assembly according to claim 4, wherein the second support metal fitting includes a plurality of contacts extending inwardly thereof.

6. A connector comprising:
a housing; and
a pair of support metal fittings provided at both end portions of the housing, each of the pair of support metal fittings having a pair of first bent portions along sides of the housing with respect to a width thereof, a second bent portion positioned between the pair of first bent portion and about one of both ends of the housing, and a pair of third bent portions extending between the pair of first bent portions and the second bent portion and connecting the pair of first bent portions to the second bent portion.

7. A connector assembly comprising:
a connector having a housing with support metal fittings receiving portions and a pair of support metal fittings disposed at both end portions of the housing, each of the pair of support metal fittings having pair of first reinforcement portions positioned about side portions of the housing and a second reinforcement portion positioned between the pair of first reinforcement portions and about one of both end portions of the housing.

8. The connector assembly according to claim 7, wherein the pair of first reinforcement portions includes angled sections having downward slopes extending toward a receiving portion positioned between the pair of first reinforcement portions.

9. The connector assembly according to claim 8, wherein the second reinforcement portion includes an end angled section having a downward slope extending toward the receiving portion.

10. The connector assembly according to claim 7, wherein each of the pair of first reinforcement portions extends about an outer and inner wall of the housing.

11. The connector assembly according to claim 10, wherein the support metal fitting includes a plurality of contacts extending inwardly thereof.
